(19) United States
(12) Patent Application Publication
(10) Pub. No.: US 2026/0228433 A1
(43) Pub. Date: Aug. 6, 2026

(54) INFORMATION EXTRACTION FROM DOMAIN-SPECIFIC DOCUMENTS

(71) Applicants: Dow Global Technologies LLC, Midland, MI (US); Rohm and Haas Company, Philadelphia, PA (US)

(72) Inventors: Zhenyu Wang, Lake Jackson, TX (US); Dale Stevenson, Scarborough (CA); Leo H. Chiang, Lake Jackson, TX (US); Ivan Castillo, Lake Jackson, TX (US); Alix Schmidt, Midland, MI (US); Birgit Braun, Lake Jackson, TX (US)

(21) Appl. No.: 19/151,054

(22) PCT Filed: Jan. 22, 2024
(86) PCT No.: PCT/US2024/012376

§ 371 Date: Jul. 25, 2025

Related U.S. Application Data
(60) Provisional application No. 63/440,966, filed on Jan. 25, 2023.

(51) Int. Cl. G06F 40/295; G06F 40/117; G06V 30/413

(52) U.S. Cl. CPC G06F 40/295; G06F 40/117; G06V 30/413

(57) ABSTRACT

Information extraction from domain-specific documents can include performing named entity recognition thereon. A regular expression tagger can tag regular expressions in the domain-specific documents without pre-annotated training sets for the regular expression tagger. Defined domain-specific terms can be augmented with terms and phrases related to the defined domain-specific terms based on rules specified for desired information about named entities to be extracted. A dictionary-based tagger can tag the defined and augmented domain-specific terms and phrases in the plurality of domain-specific documents. Conflicts of named entity recognition between the regular expression tagger and the dictionary-based tagger can be resolved. The desired information about named entities can be extracted. Classification can be performed to identify whether the domain-specific documents are related to the desired information.

### TECHNICAL FIELD

The present disclosure relates to information extraction from domain-specific documents. Such techniques can be particularly useful to gain insights and improve productivity, reliability, and safety.

### BACKGROUND

In some domains (e.g., chemical production), it may be customary for a human to manually review documents to extract information of interest. However, this can be ineffective and insufficient to scale up information extraction solutions in diverse applications across the entire company. Furthermore, the collected and/or extracted information may be incomplete because only a subset of the available documents may be examined. For example, a manufacturing department may be tasked with mining reliability related data to identify common root causes for unplanned events. As another example, an environmental, health, and safety department may be tasked with investigating the root causes of safety incidents. As yet another example, a supply chain department may be tasked with determining which customers are complaining and why. A human resources department may be interested in issues causing poor employee experience. The documents available to the company may contain relevant information, but may not be examined in sufficient detail to reveal the relevant information to the company due to time and resource constraints. The data used to derive a conclusion may be incomplete.

Natural language processing (NLP) is a subfield of linguistics, computer science, and artificial intelligence concerned with the interactions between computers and human language, and in particular, how to program computers to process and analyze large amounts of natural language data. Information extraction is the task of automatically extracting structured information from unstructured and/or semi-structured machine-readable documents and/or other electronically represented sources. Commercial and open source NLP and/or information extraction methods exist, however, training such models tends to be data demanding and data specific. For example, most NLP models require a large number of annotated documents for training the NLP models. In domain-specific contexts, there may not be sufficient annotated documents or other training materials available for the NLP models to perform with a desired accuracy. Domain-specific contexts may use domain-specific terminology that is distinct from other domains.

### SUMMARY OF THE DISCLOSURE

The present disclosure is directed to extracting information from text-based domain-specific documents, which can help companies gain insights in a wide range of applications. In the chemical company domain, examples of such applications include identifying root causes for production loss, safety incidents, and customer complaints. Examples of information that may be desired to be extracted include unit operations, chemical properties, human injuries, etc. The present disclosure is also directed to identifying documents that include the desired information (e.g., whether a particular document describes an incident in which a human was injured by mobile equipment instead of other factors). There are numerous applications in research and development related to knowledge extraction, context modeling, and document classification. The results of the information extraction can be used to improve operation reliability, safety, and/or customer experience, among other advantages. Many companies may have a large quantity of documents stored in databases such that reviewing them manually is prohibitively expensive and ineffective. Currently available information extraction solutions cannot extract the desired information in domain-specific contexts with satisfactory accuracy without significant additional training with labeled data.

In order to address such concerns, at least one embodiment provides a framework for automated information extraction for domain-specific contexts. Such a framework can include pretrained components for extracting information (e.g., locations and company names), self-tuning components that can be trained with a relatively small number of annotated data sources containing domain-specific terminology, and insight extraction components that build upon the collected information. With respect to annotated data sources or training material, “relatively small” means fewer than is recommended or required by an existing NLP solution.

The above summary is not intended to describe each disclosed embodiment or every implementation. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a block diagram of a framework for information extraction and classification of domain-specific documents.

FIG. 2 is a block diagram of a more detailed framework for information extraction and classification of domain-specific documents.

FIG. 3 is a block diagram of a framework for named entity recognition.

FIG. 4 illustrates an example result of information extraction from a domain-specific document.

FIG. 5 is a flow diagram illustrating a method for information extraction from domain-specific documents.

FIG. 6 illustrates an example machine within which a set of instructions, for causing the machine to perform various methodologies discussed herein, can be executed.

### DETAILED DESCRIPTION

Information extraction includes the processing of natural language text documents to return structured information of interest. There are various sub-tasks of information extraction, such as named entity recognition, coreference resolution, relationship extraction, and knowledge-based reasoning. These tasks can be performed in different ways including pattern matching approaches, dictionary-based approaches, machine learning based approaches, and deep learning based approaches. Most existing solutions require a substantial amount of training data in order to operate correctly on domain-specific documents. Some domains may not have sufficient training data available for the existing models to operate accurately.

At least one embodiment includes a language processing framework that can extract information of interest with high accuracy and a small amount of training data as compared to available NLP solutions. Multiple language processing approaches can be integrated into one solution to provide the described advantages, such as improving safety, reliability, customer experience, and employee experience.

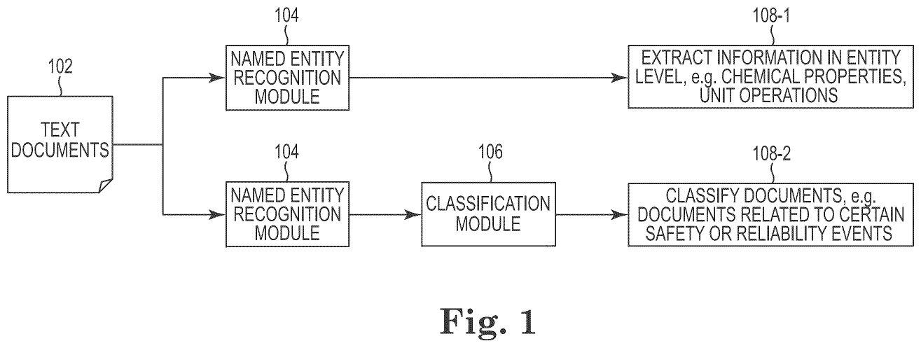

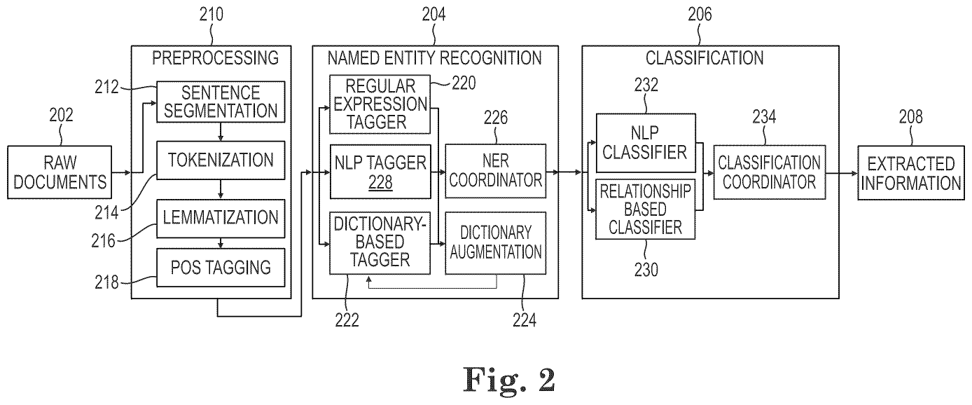

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Analogous elements within a Figure may be referenced with a hyphen and extra numeral or letter. Such analogous elements may be generally referenced without the hyphen and extra numeral or letter. For example, elements 108-1 and 108-2 in FIG. 1 may be collectively referenced as 108. As will be appreciated, elements shown in the various embodiments herein can be added, exchanged, and/or eliminated so as to provide a number of additional embodiments. In addition, as will be appreciated, the proportion and the relative scale of the elements provided in the figures are intended to illustrate certain embodiments of the present invention and should not be taken in a limiting sense.

FIG. 1 is a block diagram of a framework for information extraction and classification of domain-specific documents 102. The framework can include domain-specific documents 102, various modules 104, 106, and applications 108. As used herein, a “module” can include program instructions and/or hardware, but at least includes program instructions. In this context, “application” refers to what the framework is used for (e.g., information extraction, document classification, etc.).

As indicated, the domain-specific documents 102 are primarily text documents, although they may include graphs, images, or other non-text fields. The domain-specific documents 102 are electronic documents that may be stored in a database. The domain-specific documents 102 contain domain-specific terminology. Existing pretrained NLP models cannot recognize the domain-specific terms. It may also be difficult to customize the NLP models or otherwise modify the NLP models to be ablet to identify specific information of interest in the domain-specific documents 102. Furthermore, the available dataset from the domain-specific documents 102 is too small to adapt existing NLP models. For example, a popular and available NLP model suggests that more than 50 “true” documents per class be used to train a classification model, where “true” documents are documents that should be classified as being of interest by the classification model. Without such training the NLP model will not accurately or efficiently classify other documents. One example of a reason why insufficient data (or documents) may exist is that a company may not have a lot of accidents and therefore not a lot of accident reports to help in the environmental health and safety domain. If the NLP model is inaccurate in its classification of documents, it may not be more useful or efficient than having a human perform a review and classification process manually.

According to at least one embodiment, modules of the framework can be used for different applications. For example, the named entity recognition module 104 can be used for both an information extraction application 108-1 and a document classification application 108-2. In the example illustrated in FIG. 1, the classification module 106 is used for the classification application 108-2, but not for the information extraction application 108-1. In this example, the document classification application 108-2 may also involve information extraction, but the information extraction application 108-1 does not involve document classification. Examples of domain-specific information extraction applications 108-1 at the entity level include identifying chemical properties and identifying unit operations, among others. Examples of domain-specific document classification application 108-2 is classifying documents as being related to certain safety events or being related to certain reliability events. For example, the document classification application 108-2 can be run on each of the domain-specific documents 102 to determine whether each of them is related to a specific safety event or not. The document classification module 104 and the classification module 106 are described in more detail with respect to FIG. 2.

FIG. 2 is a block diagram of a more detailed framework for information extraction and classification of domain-specific documents 202. The framework can include an optional preprocessing module 210. The preprocessing module 210 can be configured to break the domain-specific documents 202 into words and restore them to corresponding stem words for future analysis and modeling. The preprocessing module 210 can include a sentence segmentation submodule 212, a tokenization submodule 214, a lemmatization submodule 216, and a part of speech (POS) tagging module 218. The sentence segmentation submodule 212 can be configured to identify where sentences in the domain-specific documents 202 begin and end, thereby segmenting the text into sentences. The tokenization submodule 214 can be configured to demarcate sections of a string of input characters, thereby identifying groups of characters as words. The lemmatization submodule 216 can be configured to group inflected forms of a word (e.g., verb conjugation) together so that they can be analyzed as a single term. The POS tagging submodule 218 can be configured to mark words in a text as corresponding to a part of speech based on definition and context. For example, the POS tagging submodule 218 can be configured to identify words as being nouns, verbs, adverbs, adjectives, etc. The preprocessing module 210 can operate on the domain-specific documents 202 before passing the results of the operation of the preprocessing module 210 to the named entity recognition module 204.

The named entity recognition module 204 can be configured to extract information of interest (named entities) from the domain-specific documents 202 by performing named entity recognition on the domain-specific documents 202. Examples of named entities in the safety domain include mobile equipment and human. The named entity recognition module 204 includes a regular expression tagger submodule 220, a dictionary-based tagger submodule 222, a dictionary augmentation submodule 224, and a named entity recognition (NER) coordinator 226. In some embodiments, the named entity recognition module 204 can also include an optional NLP tagger module 228.

The regular expression tagger submodule 220 can be configured to extract information based on domain-specific patterns without a pre-annotated training dataset. A domain-specific pattern can be a naming convention for entities withing a company, such as a project number, a position and identification number (as in an example below). A regular expression can be defined for such a pattern so that additional model training using annotated data is not needed to identify the pattern. A regular expression is a sequence of characters that specifies a search pattern in text. An example of a domain-specific pattern is “FT-XXX-YYY” for flowmeter YYY at XXX location. The regular expressions used by the regular expression tagger submodule 220 can be manually defined by users and/or domain experts. The regular expression tagger submodule 220 can receive the domain-specific documents 202 either directly or via the preprocessing module 210. The output of the regular expression tagger submodule 220 goes to the NER coordinator submodule 226.

The dictionary-based tagger submodule 222 can be configured to identify domain-specific terms in the domain-specific documents 202. The dictionary-based tagger submodule 222 does not require a model training step, which advantageously reduces the amount of data required versus training an accurate information extraction framework. The dictionary-based tagger submodule 222 can be populated with domain-specific codes for matching N-gram phrases that are particular to the domain. In some embodiments, the dictionary-based tagger submodule 222 can be populated manually by users and/or domain experts. The dictionary-based tagger submodule 222 can receive the domain-specific documents 202 via the preprocessing module 210. The output of the dictionary-based tagger submodule 222 goes to the NER coordinator submodule 226 and to the dictionary augmentation submodule 224.

The dictionary augmentation submodule 224 can be configured to allow users quickly and precisely to augment the domain-specific terms (e.g., N-gram phrases) in the dictionary-based tagger submodule 222 based on rules specified by the users. The initial dictionary established by subject matter experts may not cover all relevant named entities. For example, it may contain “truck” and “operator” but may not include “forklift” and “employee.” The dictionary augmentation submodule 224 can identify potential named entities of interest and provide additional named entities for the dictionary-based tagger submodule 222 to improve the resulting accuracy. The dictionary augmentation submodule 224 can operate based on given rules, such as “consider nouns following the pattern of mobile equipment and means of contact.” These noun phrases are likely to be related to human (in the safety domain, where the named entity of interest is human) because in the safety reports, an incident can be contact between a mobile equipment and a human. Such an approach is more effective than some previous approaches that find basically all noun phrases. The dictionary augmentation submodule 224 works with other types of words, phrases, and other types of relationships. The dictionary augmentation submodule 224 can operate in a semiautomatic manner in which words, phrases, or relationships can be identified by the submodule, then optionally confirmed by a user. The dictionary augmentation submodule 224 can receive the domain-specific documents 202 via the preprocessing module 210. The output of the dictionary augmentation submodule 224 goes to the NER coordinator submodule 226 and to the dictionary-based tagger submodule 222. As such, the dictionary augmentation submodule 224 can function to expand the lexicon of the dictionary-based tagger submodule 222 while the dictionary-based tagger submodule 222 can improve the rules and identification of phrases by the dictionary augmentation submodule 224.

The NLP tagger submodule 228 is an optional feature of the framework. The NLP tagger submodule 228 can use an artificial neural network (ANN) to help identify named entities and/or map items in the text of the domain-specific documents 202 to named entities and what the relationship between the items in the text and the named entities may be. In general, NLP taggers require a substantial amount of training data to achieve high accuracy. For named entities with sufficient training data and that are not domain-specific (e.g., to the chemical industry), such as location and/or institution, a pretrained NLP tagger submodule 228 can be employed. For other domains that have insufficient training data and that are domain-specific (e.g., to the chemical industry), the NLP tagger submodule 228 may be omitted or bypassed for the framework. The NLP tagger submodule 228 can receive the domain-specific documents 202 via the preprocessing module 210. The output of the NLP tagger submodule 228 goes to the NER coordinator submodule 226.

ANNs can process information by modeling a network of neurons, such as neurons in a human brain, to process information (e.g., stimuli) that has been sensed in a particular environment. Similar to a human brain, neural networks typically include a multiple neuron topology (e.g., that can be referred to as artificial neurons). An ANN operation refers to an operation that processes, to perform a given task, inputs using artificial neurons. The ANN operation may involve performing various machine learning algorithms to process the inputs.

Deep learning is a type of machine learning that has been enabled by improvements in computational power, data availability, and software tools. Deep learning can apply ANNs to accomplish tasks once thought impossible for a computer to perform. The “deep” of deep learning refers to the use of multiple layers in an ANN. These layers extract successively higher order features from a raw input. Each layer of an ANN can be represented as a column of nodes. The nodes, which can correspond to artificial neurons, can receive various inputs. Interconnection regions can couple nodes between different layers, which can be indicated by lines coupling the nodes. Nodes can receive inputs from other nodes via the interconnection regions. An interconnection region can couple each node of a first layer with each node of a second layer. The ANN can be configured in a training process in which the various connections in the interconnection regions are assigned a weight value or updated with a new weight value that is used for operations or computations at the nodes. The training process may be different depending on a particular application or use of the ANN. For instance, an ANN may be trained for language processing and/or information extraction as described herein, or another processing or computational task.

The ANN can include an output layer, represented by the last column of nodes. The last column of nodes may be referred to as output nodes. Each of the output nodes can be coupled to receive inputs from the nodes of the previous layer of nodes. The process of receiving usable outputs at the output layer of output nodes as a result of inputs fed into the nodes at the first layer may be referred to as inference or forward propagation. That is, input signals representative of some real-world phenomena or application may be fed into a trained ANN and through inference that occurs as a result of calculations enabled by various nodes and interconnects, a result may be output. In the case of an ANN trained for named entity recognition, the input may be signals representative of the text of a domain-specific document 202 (or a preprocessed document) and the output may be signals representative of the named entity.

The NER coordinator submodule 226 can be configured to determine final named entity assignments. Because multiple taggers are employed in the framework (e.g., the regular expression tagger submodule 220 and the dictionary-based tagger submodule 222), conflicts of named entities recognized by the taggers can arise. The NER coordinator submodule 226 can resolve these conflicts by having the final named entity assignment authority for the domain-specific documents 202. For example, the NLP tagger submodule 228 may tag “Dow” as a person, while the dictionary-based tagger 222 may tag “Dow” as an organization. The NER coordinator submodule 226 can resolve this example conflict by tagging “Dow” as an organization. In some embodiments, the NER coordinator submodule 226 can resolve conflicts by assigning weights to each tagger (e.g., the dictionary-based tagger submodule 222 can be assigned a greater weight than the NLP tagger submodule 228). Among NLP taggers, higher weights can be assigned to those that have better performance in a small testing dataset. A calibration dataset can be used to examine the accuracy of different taggers and respective weights can be assigned based on those different levels of accuracy. In general, the dictionary-based tagger submodule 222 and regular expression tagger submodule 220 may be assigned greater weights than the NLP taggers due to their inherently greater reliability based on domain-specific knowledge. The NER coordinator submodule 226 can receive input from the regular expression tagger submodule 220, the dictionary-based tagger submodule 222, and the NLP tagger submodule 228 (if the framework is so equipped). For some applications, the NER coordinator submodule 226 can be configured to provide the extracted information 208 as an output of the framework (e.g., where the extracted information 208 is one or more named entities). For some applications, the NER coordinator submodule 226 can provide an output to the classification module 206 (e.g., where the extracted information 208 is document classification).

The classification module 206 can be configured to determine whether each of the domain-specific documents 202 is of interest. For example, in the safety domain, the classification module 206 can find documents related to injuries caused by mobile equipment. In such an example, the named entity recognition module 204 would identify the named entities human and mobile equipment, then the classification module 206 would identify information in the domain-specific documents 202 related to the named entities to determine if the documents are of interest. The classification module 206 includes a relationship-based classifier submodule 230. In some embodiments, the classification module 206 can also include an NLP classifier submodule 232 and a classification coordinator submodule 234.

The relationship-based classifier submodule 230 can be configured to apply relationships among the named entities to classify the domain-specific documents 202. The configuration of the relationship-based classifier submodule 230 can be based on input from experts so that its classifications do not need to be learned with a training dataset. For example, with respect to the safety domain, the relationship of mobile equipment and human connected by means of contact can be applied to classify a domain-specific document 202 as being related to safety. In this example, the relationship used by the relationship-based classifier submodule 230 is that if a report mentions the named entities in either of the following sequences “Mobile Equipment”, “Means of Contact”, “Human”, or “Human”, “Means of Contact”, “Mobile Equipment”, then the report relates to the safety domain. The relationship-based classifier submodule 230 can be accurate without requiring significant or any training data. To the extent that the relationship-based classifier submodule 230 is trained, it is trained at the input document level. The relationship-based classifier submodule 230 is a rules-based classifier that generally does not extrapolate information beyond the relationships specified in its underlying programming. The relationship-based classifier submodule 230 can receive the output of the named entity recognition module 204 (e.g., named entities) and the domain-specific documents 202. The output of the relationship-based classifier submodule 230 goes to the classification coordinator submodule 234 or is directly output as the extracted information 208.

The NLP classifier submodule 232 is an optional feature of the framework. The NLP classifier submodule 232 can be configured to use the characteristic vocabularies in the domain-specific documents 202 to classify them by converting natural language inputs into semantic categories. Use of the NLP classifier submodule 232 is relatively more data demanding than the operation of the relationship-based classifier submodule 230. However, the NLP classifier submodule 232 can extrapolate from the characteristic vocabularies in the domain-specific documents 202 using an ANN to learn based on previous inputs and results. The integration of the NLP classifier submodule 232 with the relationship-based classifier submodule 230 in the classification module 206 can provide more accurate results than either submodule operating on its own. The NLP classifier submodule 232 can receive the output of the named entity recognition module 204 (e.g., named entities) and the domain-specific documents 202. The output of the NLP classifier submodule 232 goes to the classification coordinator submodule 234.

The classification coordinator submodule 234 is an optional feature of the framework that can be used when the classification module 206 includes the use of the NLP classifier submodule 232. The classification coordinator submodule 234 can be configured to determine final classifications of the domain-specific documents 202. For embodiments in which multiple classifiers are employed in the framework (e.g., the relationship-based classifier submodule 230 and the NLP classifier submodule 232), conflicts of classifications determined by the classifiers can arise. The classification coordinator submodule 234 can resolve these conflicts by having the final classification authority for the domain-specific documents 202. The classification coordinator submodule 234 can assign weights to different classifiers in order to resolve the conflicts. For example, relationship-based classifications may be assigned a greater weight than NLP classifications. Among different NLP classifications, weights can be assigned based on testing performance results of the NLP classifiers. The classification coordinator submodule 234 can receive input from the relationship-based classifier submodule 230 and the NLP classifier submodule 232. The classification coordinator submodule 234 can be configured to provide the extracted information 208 as the output of the classification coordinator submodule 234 and of the framework (e.g., where the extracted information 208 is document classification).

The framework for information extraction can incorporate domain-specific terminologies via the regular expression tagger submodule 220, the dictionary-based tagger submodule 222, the dictionary-augmentation submodule 224, and the relationship-based classifier submodule 230. Pretrained NLP models can be incorporated into the framework via the NLP tagger submodule 228 and/or the NLP classifier submodule 232 to provide non-domain specific insights. The NER coordinator submodule 226 and/or the classification coordinator submodule 234 can resolve conflicts from the different information extraction methodologies. The framework can automatically extract information with high accuracy using a minimal training dataset versus some previous approaches that would otherwise require training NLP models for domain-specific tasks. The integration of domain-specific submodules with the NLP submodules can provide superior accuracy over existing commercially available solutions while using lesser training data than is required by existing solutions. The domain-specific submodules are flexible and highly customizable for different domain-specific tasks and require minimal training data to be tuned to those different domain-specific tasks.

The information extraction framework was tested in two different case studies. The first was to mine safety incidents related to human and mobile equipment means of contact. The second was to mine reliability incidents in the chemical production business. Use of the framework is not limited to these domains.

In the safety incidents information extraction case, the goal was to identify all incidents related to human injuries caused by mobile equipment in order to reduce such incidents in the future. The framework correctly identified 35 out of 41 human and mobile equipment means of contact incidents out of about 9000 total incidents in the database, taking 5 minutes to complete the task. Each incident was identified by a domain-specific document. A commercially available tool correctly identified 21 out of the 41 targeted incidents correctly, taking 22 minutes to complete the task. The superior results of the disclosed framework are attributed to the customized named entity recognition module 204 and the customized classification module 206 that are not included in the commercially available model. The commercially available model documentation requested at least 50 incidents of each type to be identified in a training set, which exceeded the amount available in the 9000 incident data set. The results identified the piece of mobile equipment that was most likely to injure workers, thereby reducing what would otherwise have been a study of all pieces of mobile equipment to focus on those most relevant to the problem. This also obviated the need to manually review the 9000 domain-specific documents, which would have been time consuming. Technology improvements, best practices, and potential operating procedure changes for the types of equipment identified through text data mining can be evaluated to protect workers from means of contact with this equipment and reduced such incidents.

In the second case study, the goal was to extract the equipment failures from reliability documents to reveal and prioritize improvement opportunities. The framework identified a similar amount of named entities (e.g., failures, equipment, etc.) compared to the commercially available tool. The framework more accurately recognized domain-specific terms and phrases than the commercially available tool.

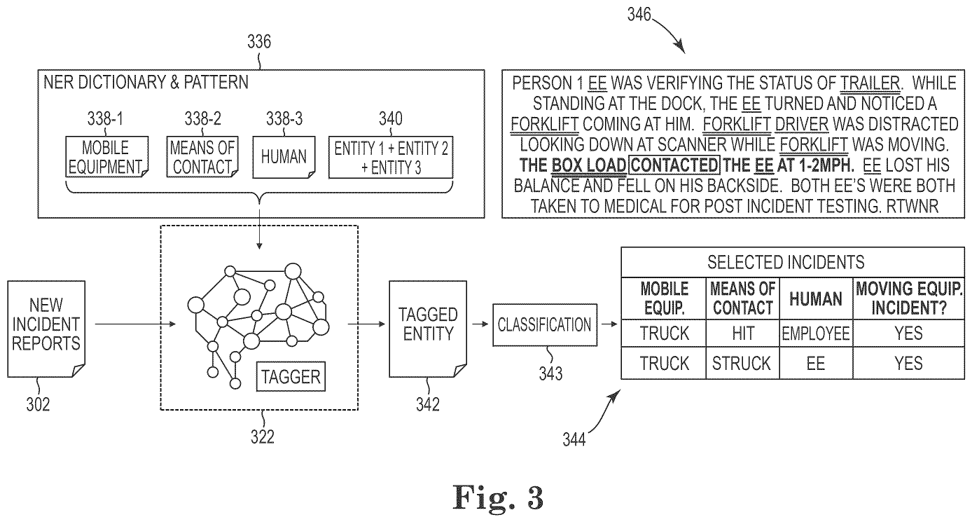

FIG. 3 is a block diagram of a framework for named entity recognition. The framework for named entity recognition can receive domain-specific documents 302, such as new incident reports. Named entity recognition can be performed by one or more taggers, such as a dictionary-based tagger 322, which is analogous to the dictionary-based tagger submodule 222 illustrated in FIG. 2. The dictionary 336 of the dictionary-based tagger 322 can include definitions of named entities 338 and relationships 340 between named entities. Non-limiting examples of the named entities 338 include mobile equipment 338-1, means of contact 338-2, and human 338-3. A generic representation of a relationship between named entities is illustrated as “Entity 1+Entity 2+Entity 3” at 340. The dictionary-based tagger 322, after operating on the domain-specific document 302 can output an indication of a tagged entity 342 identified from the domain-specific document 302. Classification can be performed to determine whether the document 302, having the entities tagged, is related to desired information, as illustrated at 343.

Box 344 in FIG. 3 illustrates some examples of definitions of named entities. For example, the named entity “mobile equipment” includes the definition “truck”. The named entity “means of contact” includes the definitions “hit” and “struck”. The named entity “human” includes “employee” and “EE”. Box 344 also illustrates an example of extracted information and/or document classification, “moving equipment incident?”. The example results illustrated are both “yes”, however, although not specifically illustrated, “no” would also be a possible result.

FIG. 3 includes an example snippet of text 346 from a domain-specific document 302. The text reads:
PERSON 1 EE was verifying the status of trailer. While standing at the dock, the EE turned and noticed a forklift coming at him. Forklift driver was distracted looking down at scanner while forklift was moving. The box load contacted the EE at 1-2 mph. EE lost his balance and fell on his backside. Both EE's were both taken to medical for post incident testing. RTWNR

The text 346 has been operated on by the tagger 322 and various named entities have been recognized. The category of human named entities has been identified by single underlining as various instances of “EE”. The category of mobile equipment named entities has been identified by double underlining as instances of “trailer”, “forklift”, and “box load”. The category of means of contact named entities has been identified by boxing as an instance of “contacted”. A relationship between named entities has been identified as shown in bold font as an instance of “The box load contacted the EE at 1-2 mph.”

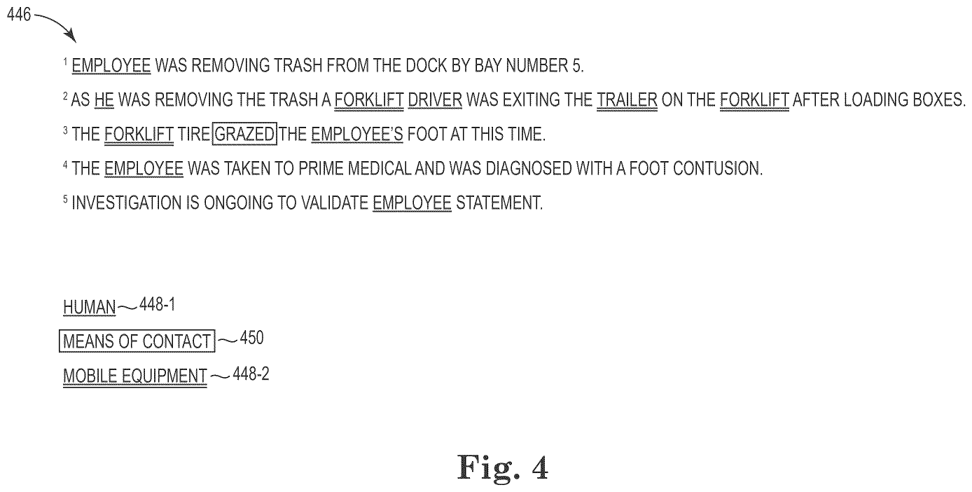

FIG. 4 illustrates an example result of information extraction from a domain-specific document. The domain-specific document includes text 446, which reads:
Employee was removing trach from the dock by bay number 5. As he was removing the trash a forklift driver was exiting the trailer on the forklift after loading boxes. The forklift tire grazed the employee's foot at this time. The employee was taken to Prime Medical and was diagnosed with a foot contusion. Investigation is ongoing to validate employee statement.

Various instances of the named entity “human” 448-1 have been identified by single underlining as “employee”, “he”, “driver”, and “employee's”. Various instances of the named entity “mobile equipment” 448-2 have been identified by double underlining as “forklift” and “trailer”. An instance of a relationship between named entities “means of contact” 450 is identified as “grazed”. Specifically, the means of contact 450 “grazed” occurs between the mobile equipment 448-2 named entity “forklift” and the human named entity 448-1 “employee's” in line 3 of the text 446.

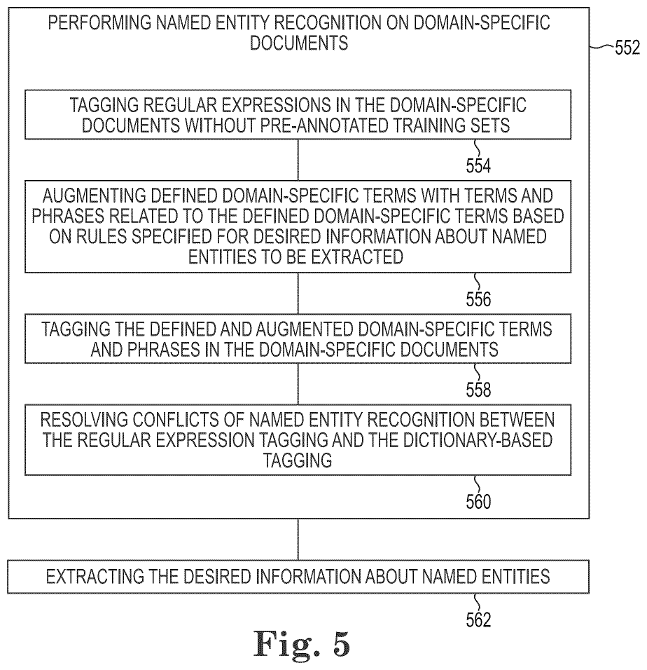

FIG. 5 is a flow diagram illustrating a method for information extraction from domain-specific documents. At block 552, the method can include performing named entity recognition on domain-specific documents. Named entity recognition can include, at block 554, tagging regular expressions in the domain-specific documents without pre-annotated training sets. At block 556, named entity recognition can include augmenting defined domain-specific terms with terms and phrases related to the defined domain-specific terms based on rules specified for desired information about named entities to be extracted. At block 558, named entity recognition can include tagging the defined and augmented domain-specific terms and phrases in the domain-specific documents. At block 560, named entity recognition can include resolving conflicts of named entity recognition between the regular expression tagging and the dictionary-based tagging. In some embodiments, named entity recognition can further include NLP tagging the plurality of domain-specific documents. In such embodiments, the conflict resolution of block 560 can further resolve any additional conflicts of named entity recognition introduced by the NLP tagging.

At block 562, the method can include extracting the desired information about named entities. Extracting the desired information can include identifying failure information related to a chemical process. Extracting the desired information can include identifying those of the domain-specific documents that re related to safety incidents. Other domain-specific examples of extracting the desired information are possible.

Although not specifically illustrated in FIG. 5, the method can further include preprocessing the domain-specific documents before performing named entity recognition. The domain-specific documents can be preprocessed by sentence segmenting, tokenizing, lemmatizing, and part of speech tagging the domain-specific documents.

Although not specifically illustrated in FIG. 5, the method can further include performing classification to identify whether each of the plurality of domain-specific documents is related to the desired information after resolution of the conflicts of named entity recognition. Performing classification can include relationship classifying each of the plurality of domain-specific documents based on application of relationships among results of the named entity recognition, NLP processing classifying each of the plurality of domain-specific documents, and resolving conflicts of classification between the relationship classifying and the NLP classifying. The NLP classifying can be performed by an NLP classifier submodule trained at a document level based on characteristic vocabularies in the domain-specific documents. Relationship classifying can be performed by a relationship-based classifier submodule that does not require training data.

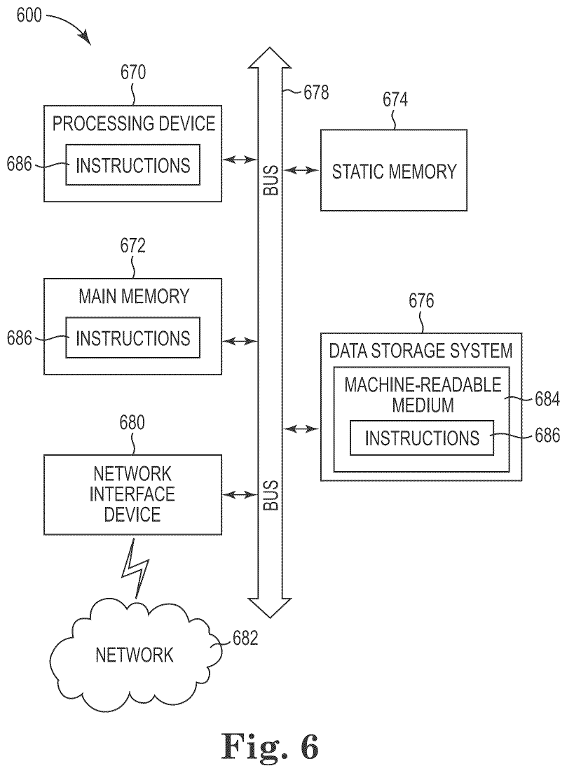

The method illustrated in FIG. 5 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the system shown in FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

FIG. 6 illustrates an example machine 600 within which a set of instructions, for causing the machine 600 to perform various methodologies discussed herein, can be executed. The machine 600 can be connected (e.g., networked) to other machines in a LAN, an intranet, an extranet, and/or the Internet. The machine 600 can operate in the capacity of a server or a client machine in client-server network environment, as a peer machine in a peer-to-peer (or distributed) network environment, or as a server or a client machine in a cloud computing infrastructure or environment.

The machine 600 can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine 600 is illustrated, the term “machine” shall also be taken to include any collection of machines that individually or jointly execute a set (or multiple sets) of instructions to perform any one or more of the methodologies discussed herein.

The example machine 600 includes a processing device 670, a main memory 672 (e.g., read-only memory (ROM), flash memory, dynamic random access memory (DRAM) such as synchronous DRAM (SDRAM) or Rambus DRAM (RDRAM), etc.), a static memory 674 (e.g., flash memory, static random access memory (SRAM), etc.), and a data storage system 676, which communicate with each other via a bus 678.

The processing device 670 represents one or more general-purpose processing devices such as a microprocessor, a central processing unit (CPU), or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 670 can also be one or more special-purpose processing devices such as an application specific integrated circuit (ASIC), a field programmable gate array (FPGA), a digital signal processor (DSP), network processor, or the like. The processing device 670 is configured to execute instructions 686 for performing the operations and steps discussed herein. The machine 600 can further include a network interface device 1012 to communicate over the network 682.

The data storage system 676 can include a machine-readable storage medium 684 (also known as a computer-readable medium) on which is stored one or more sets of instructions 686 or software embodying any one or more of the methodologies or functions described herein. The instructions 686 can also reside, completely or at least partially, within the main memory 672 and/or within the processing device 670 during execution thereof by the machine 600, the main memory 672 and the processing device 670 also constituting machine-readable storage media.

In one embodiment, the instructions 686 include instructions to implement functionality corresponding to the framework for information extraction from domain-specific documents described herein. While the machine-readable storage medium 684 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer implemented method for information extraction from domain-specific documents, comprising:
performing named entity recognition on a plurality of domain-specific documents by:
tagging, by a regular expression tagger, regular expressions in the plurality of domain-specific documents without pre-annotated training sets for the regular expression tagger;
augmenting defined domain-specific terms with terms and phrases related to the defined domain-specific terms based on rules specified for desired information about named entities to be extracted;
tagging, by a dictionary-based tagger, the defined and augmented domain-specific terms and phrases in the plurality of domain-specific documents; and
resolving conflicts of named entity recognition between the regular expression tagger and the dictionary-based tagger; and
extracting the desired information about named entities.

2. The method of claim 1, wherein extracting the desired information comprises identifying failure information related to a chemical process.

3. The method of claim 1, wherein extracting the desired information comprises identifying those of the plurality of domain-specific documents that are related to safety incidents.

4. The method of claim 1, further comprising performing classification to identify whether each of the plurality of domain-specific documents is related to the desired information after resolution of the conflicts of named entity recognition, wherein performing classification includes:
relationship classifying each of the plurality of domain-specific documents based on application of relationships among results of the named entity recognition;
natural language processing (NLP) classifying each of the plurality of domain-specific documents; and
resolving conflicts of classification between the relationship classifying and the NLP classifying.

5. The method of claim 4, wherein NLP classifying comprises NLP classifying by an NLP classifier submodule trained at a document level based on characteristic vocabularies in the plurality of domain-specific documents.

6. The method of claim 4, wherein relationship classifying comprises relationship classifying by a relationship-based classifier submodule that does not require training data.

7. The method of claim 1, wherein performing named entity recognition further comprises NLP tagging the plurality of domain-specific documents; and
wherein resolving conflicts of named entity recognition further comprises resolving conflicts between the NLP tagging, the regular expression tagging, and the dictionary tagging.

8. The method of claim 1, further comprising preprocessing the plurality of domain-specific documents by:
sentence segmenting the plurality of domain-specific documents;
tokenizing the plurality of domain-specific documents;
lemmatizing the plurality of domain-specific documents; and
part of speech tagging the plurality of domain-specific documents.

9. A system for information extraction from domain-specific documents, comprising:
a memory storing:
a preprocessing module configured to break the domain-specific documents into words;
a named entity recognition module including:
a regular expression tagger submodule configured to tag groups of words as named entities in the domain-specific documents based on domain-specific patterns;
a dictionary-based tagger submodule configured to tag domain-specific terms and phrases as named entities in the domain-specific documents;
a dictionary augmentation submodule configured to augment the domain-specific terms in the dictionary-based tagger submodule based on specified rules;
a natural language processing (NLP) tagger submodule configured to tag named entities in the domain-specific documents;
a named entity recognition coordinator configured to resolve conflicts of named entity assignment between the regular expression tagger submodule, the dictionary-based tagger submodule, and the NLP tagger submodule;
a classification module including:
a relationship-based classifier submodule configured to apply relationships among the named entities to classify the domain-specific documents;
an NLP classifier submodule configured to classify the domain-specific documents based on characteristic vocabularies in the domain-specific documents; and
a classification coordinator submodule configured to resolve conflicts of classification between the relationship-based classifier submodule and the NLP classifier submodule; and
a processor coupled to the memory and configured to execute the modules and submodules stored in the memory.

10. The system of claim 9, wherein the processor is configured optionally to execute the named entity recognition module without executing the NLP tagger submodule.

11. The system of claim 9, wherein the processor is configured optionally to execute the classification module without executing the NLP classifier submodule and the classification coordinator submodule.

12. The system of claim 9, wherein the processor is configured to execute the regular expression tagger submodule without a pre-annotated training dataset.

13. The system of claim 9, wherein the NLP tagger submodule is pretrained without domain-specific data.

14. The system of claim 13, wherein the NLP classifier submodule is trained at the domain-specific document level without a separate domain-specific classification training dataset.

15. The system of claim 9, wherein the preprocessing module includes:
a sentence segmentation submodule configured to segment text of the domain-specific documents into sentences;
a tokenization submodule configured to identify groups of characters in the domain-specific documents as words;
a lemmatization submodule configured to group inflected forms of a word together as a single term in the domain-specific documents; and
a part of speech tagging submodule configured to mark words in the text of the domain-specific documents as corresponding to a part of speech.
